(19) United States
(12) Patent Application Publication
(10) Pub. No.: US 2013/0078537 A1
(43) Pub. Date: Mar. 28, 2013

(54) OXYGEN-CONSUMING ELECTRODE AND PROCESS FOR PRODUCTION THEREOF

(71) Applicants: Jakob Jörissen, Dortmund (DE); Gregor Polcyn, Dortmund (DE); Florian Verfuß, Dortmund (DE); Gabriel Toepell, Dortmund (DE)

(72) Inventors: Jakob Jörissen, Dortmund (DE); Gregor Polcyn, Dortmund (DE); Florian Verfuß, Dortmund (DE); Gabriel Toepell, Dortmund (DE)

(73) Assignee: Bayer Intellectual Property GmbH, Monheim (DE)

(21) Appl. No.: 13/616,309

(22) Filed: Sep. 14, 2012

(30) Foreign Application Priority Data
Sep. 23, 2011 (DE) 102011083316.1

(51) Int. Cl. C25B 11/08; H01M 4/92; H01M 8/22; H01M 8/08; C25B 9/00; H01M 4/88

(52) U.S. Cl. 429/405; 204/284; 204/275.1; 205/57; 429/501

(57) ABSTRACT

An oxygen-consuming electrode is described, more particularly for use in chloralkali electrolysis, comprising a novel catalyst coating, as is an electrolysis apparatus. Also described is a production process for the oxygen-consuming electrode and the use thereof in chloralkali electrolysis or fuel cell technology. The oxygen-consuming electrode is based on a gas diffusion layer as a porous film of a fluorinated polymer, into which fine crystal needles of a catalyst metal have been introduced as the catalytically active component and are connected with electrical conduction to the current collector.

### BACKGROUND OF THE INVENTION

The invention relates to an oxygen-consuming electrode, more particularly for use in chloralkali electrolysis, comprising a novel catalyst coating based on crystal needles of a catalyst metal, and to an electrolysis apparatus. The invention further relates to a production process for the oxygen-consuming electrode and the use thereof in chloralkali electrolysis or fuel cell technology.

The invention proceeds from oxygen-consuming electrodes known per se, which take the form of gas diffusion electrodes and typically comprise an electrically conductive carrier and a gas diffusion layer comprising a catalytically active component.

Various proposals for operation of the oxygen-consuming electrodes in electrolysis cells on the industrial scale are known in principle from the prior art. The basic idea is to replace the hydrogen-evolving cathode in the electrolysis (for example in chloralkali electrolysis) with the oxygen-consuming electrode (cathode). An overview of the possible cell designs and solutions can be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-consuming electrode—also called OCE for short hereinafter—has to meet a series of requirements to be usable in industrial electrolysers. For instance, the catalyst and all other materials used have to be chemically stable towards approx. 32% by weight sodium hydroxide solution and towards pure oxygen at a temperature of typically 80-90° C. Similarly, a high degree of mechanical stability is required, such that the electrodes can be installed and operated in electrolysers with a size typically more than 2 m² in area (industrial scale). Further properties are: high electrical conductivity, low layer thickness, high internal surface area and high electrochemical activity of the electrocatalyst. Suitable hydrophobic and hydrophilic pores and a corresponding pore structure for conduction of gas and electrolyte are likewise necessary, as is such imperviosity that gas and liquid space remain separate from one another. Long-term stability and low production costs are further particular requirements on an industrially usable oxygen-consuming electrode.

A further development trend for utilization of OCE technology in chloralkali electrolysis is that of direct application of the ion exchanger membrane, which separates the anode space from the cathode space in the electrolysis cell, to the OCE without a gap containing sodium hydroxide solution. This arrangement is also referred to in the prior art as the zero gap arrangement. This arrangement is typically also employed in fuel cell technology. A disadvantage here is that the sodium hydroxide solution which forms has to be passed through the OCE to the gas side and then flows downwards at the OCE. In the course of this, the pores in the OCE must not be blocked by the sodium hydroxide solution, and there must not be any crystallization of sodium hydroxide in the pores. It has been found that very high sodium hydroxide solution concentrations can arise here too, but the ion exchanger membrane lacks long-term stability to these high concentrations (Lipp et al, J. Appl. Electrochem. 35 (2005)1015—Los Alamos National Laboratory “Peroxide formation during chlor-alkali electrolysis with carbon-based ODC”).

According to the prior art, OCEs have a pore structure in which the use of a finely distributed hydrophobic pore system, usually based on PTFE (polytetrafluoroethylene, e.g. Teflon), makes all sites within the OCE accessible to the gas used on the cathode side. On the other hand, the hydrophilic catalyst covered by an electrolyte film must also be sufficiently finely distributed in order that a maximum surface area is available for the electrochemical reaction, which leads to low cell voltages. In the customary manufacturing processes, the dry or wet process, PTFE particles and catalyst particles are used for production of the OCEs. The mixing and further processing of these particles always leads, in the course of the manufacturing process, to regions in which there are relatively large, electrolyte-flooded agglomerates of catalyst particles, which do not contain any gas pores. The catalyst in the interior of such agglomerates is virtually inactive since the gas molecules cannot diffuse in a sufficient amount to this catalyst. Thus, a large amount of the catalyst material remains unutilized.

Bidault et al. (2010, Journal of Power Sources, “A novel cathode for alkaline fuel cells based on a porous silver membrane”, 195, pp. 2549-2556) have developed a gas diffusion cathode based on a porous silver membrane. The aim here was to achieve a high surface area of the catalyst by the use of silver with fine pores. It was found here that coating of the silver pores with PTFE was necessary to prevent complete flooding of the pores by the electrolyte, since the pores are otherwise no longer accessible to the reaction gas. A disadvantage of this type of gas diffusion cathode is that it is not possible to choose an infinitely small pore size of the silver membrane and hence to increase the surface area significantly, since the PTFE coating can no longer penetrate into the pores. Moreover, excessive coating of the pores in turn reduces the silver surface area available for the electrocatalytic reaction.

It is an object of the present invention to provide an oxygen-consuming electrode, especially for use in chloralkali electrolysis, which overcomes the above disadvantages and thus ensures better exploitation of the catalyst.

### EMBODIMENTS OF THE INVENTION

An embodiment of the present invention is an oxygen-consuming electrode comprising a current collector and a gas diffusion layer with a catalytically active component, wherein the gas diffusion layer is in the form of a porous film of a fluorinated polymer into which fine catalyst particles of a catalyst metal with a mean diameter in the range from 0.05 μm to 5 μm and a mean length in the range from 10 μm to 700 μm have been introduced as the catalytically active component and are connected with electrical conduction to the current collector.

Another embodiment of the present invention is the above oxygen-consuming electrode, wherein the catalyst comprises silver as the catalytically active component.

Another embodiment of the present invention is the above oxygen-consuming electrode, wherein the catalyst particles have a mean diameter in the range from 0.1 μm to 5 μm and a mean length in the range from 10 μm to 700 μm.

Another embodiment of the present invention is the above oxygen-consuming electrode, wherein the current collector is in the form of a pervious, electrically conductive, flat structure.

Another embodiment of the present invention is the above oxygen-consuming electrode, wherein the current collector is in the form of a flexible textile structure.

Another embodiment of the present invention is the above oxygen-consuming electrode, wherein the material used for the current collector is nickel or silver-coated nickel.

Another embodiment of the present invention is the above oxygen-consuming electrode, wherein the porosity of the film of the fluorinated polymer is from 40% to 90%.

Another embodiment of the present invention is the above oxygen-consuming electrode, wherein the pores of the film of the fluorinated polymer have a mean diameter of from 0.1 μm to 10 μm.

Another embodiment of the present invention is the above oxygen-consuming electrode, wherein the density of the film of the fluorinated polymer is 0.3 to 1.8 g/cm³.

Another embodiment of the present invention is the above oxygen-consuming electrode, wherein the catalyst particles consist of silver.

Another embodiment of the present invention is the above oxygen-consuming electrode, wherein the catalyst particles have been deposited electrolytically on the current collector and in the pores of the film.

Yet another embodiment of the present invention is an alkaline fuel cell or a metal/air battery comprising the above oxygen-consuming electrode.

Yet another embodiment of the present invention is an electrolysis apparatus comprising the above oxygen-consuming electrode as an oxygen-consuming cathode.

Yet another embodiment of the present invention is a process for producing the above oxygen-consuming electrode, comprising at least the steps of:
A) providing a PTFE film and a current collector in the form of a pervious, electrically conductive, flat structure, which reaches into the film from step A) to a depth of up to at least half and at most ⅔ of the thickness of the porous film, and optionally bonding the film to the current collector by pressing,
B) impregnating the film of a fluorinated polymer, with a volatile organic solvent, and then at least partly displacing the solvent with water or an aqueous metal salt solution, optionally in the presence of additives,
C) optionally subsequently pressing the current collector into the film from step A) to a depth reaching up to at least half and at most ⅔ of the thickness of the porous film,
D) electrolytic deposition of the catalyst particles in the presence of aqueous metal salt solutions by an electrolysis operation in which the current collector serves as the cathode (3), and in the course of which the catalyst particles of the catalyst metal grow onto the current collector,
E) rinsing the oxygen-consuming electrode formed in D) with water and alcohol and then drying the oxygen-consuming electrode.

Another embodiment of the present invention is the above process, wherein the current collector has direct contact connection in the electrolytic deposition D), or the current is supplied through a graphite sheet (1) on which the current collector rests and a graphite spray intermediate layer (2) which has been applied to the graphite sheet (1), and in that the graphite sheet (1) and the graphite spray intermediate layer (2) are removed again after the electrolytic deposition D).

Yet another embodiment of the present invention is an oxygen-consuming electrode obtained from the above process.

Another embodiment of the present invention is the above oxygen-consuming electrode, wherein the porous film of a fluorinated polymer is porous polytetrafluoroethylene (PTFE) film.

Another embodiment of the present invention is the above oxygen-consuming electrode, wherein the pervious, electrically conductive, flat structure is a metallic mesh, nonwoven, foam, woven, braid or knit, or of an expanded metal.

Another embodiment of the present invention is the above oxygen-consuming electrode, wherein the flexible textile structure is formed from metal filaments.

Another embodiment of the present invention is the above oxygen-consuming electrode, wherein the pores of the film of the fluorinated polymer have a mean diameter of from 0.2 to 2 μm.

### DETAILED DESCRIPTION OF THE INVENTION

The stated object is achieved in accordance with the invention by an oxygen-consuming electrode at least comprising a current collector and a gas diffusion layer with a catalytically active component, characterized in that the gas diffusion layer is in the form of a porous film of a fluorinated polymer, especially in the form of a porous polytetrafluoroethylene (PTFE) film, into which fine catalyst particles of a catalyst metal with a mean diameter in the range from 0.05 μm to 5 μm and a mean length in the range from 10 μm to 700 μm have been introduced as the catalytically active component and are connected with electrical conduction to the current collector.

The length to diameter ratio of the catalyst particles is preferably at least 2:1, more preferably at least 3:1. The catalyst particles preferably have a mean diameter in the range from 0.1 μm to 5 μm and a mean length in the range from 10 μm to 700 μm.

It has been found that, surprisingly, especially the use of a porous PTFE film with such fine catalyst particles produces a high catalyst surface area which has good accessibility for the gas via the gas pores present in the PTFE film, and for the water and hence the ions involved in the reaction via the electrolyte film around the catalyst particles.

A preferred oxygen-consuming electrode is characterized in that the catalyst comprises silver as the catalytically active component.

The current collector may especially be in the form of a mesh, nonwoven, foam, woven, braid, knit or expanded metal, or another pervious flat structure. The current collector is preferably a flexible textile structure, especially formed from metal filaments. Particularly suitable materials for the current collector are nickel and silver-coated nickel.

In a further preferred variant of the oxygen-consuming electrode, the density of the film of the fluorinated polymer is 0.3 to 1.8 g/cm³.

In a further preferred variant of the oxygen-consuming electrode, the pore diameter of the film of the fluorinated polymer is 0.1 to 10 μm; the mean pore diameter is preferably 0.2 to 2 μm.

In another preferred variant of the oxygen-consuming electrode, the porosity of the film of the fluorinated polymer is from 40% to 90%. A particularly preferred version of the novel oxygen-consuming electrode is characterized in that the catalyst particles consist of silver.

In a further particularly preferred variant of the novel oxygen-consuming electrode, the catalyst particles have been deposited electrolytically, commencing on the current collector and subsequently in the pores of the film.

The invention further provides a process for producing an oxygen-consuming electrode, comprising at least the steps of:
A) providing a PTFE film and a current collector in the form of a pervious, electrically conductive, flat structure, especially of a metallic mesh, nonwoven, foam, woven, braid or knit, or of an expanded metal, which reaches into the film from step A) to a depth of up to at least half and at most ⅔ of the thickness of the porous film, and optionally bonding the film to a current collector by pressing,
B) impregnating the film of a fluorinated polymer, especially of a porous PTFE film, with a volatile organic solvent, preferably a C₁ to C₆ alcohol, more preferably with isopropyl alcohol, and then at least partly displacing the solvent with water or an aqueous metal salt solution, especially based on at least one metal salt from the group of: silver salts, preferably silver nitrate, silver methanesulphonate, potassium silver cyanide, potassium silver thiosulphate, silver lactate, or platinum salts, especially Pt(NO₃)₂ or H₂PtCl₆, or nickel salts and copper salts, especially in an electrolysis bath, also optionally in the presence of additives such as brighteners, especially thiourea, saccharin,
C) optionally subsequently pressing a current collector into the film from step A) to a depth reaching up to at least half and at most ⅔ of the thickness of the porous film,
D) electrolytic deposition of the catalyst particles in the presence of aqueous metal salt solutions, especially based on at least one metal salt from the group of: silver salts, preferably silver nitrate, silver methanesulphonate, potassium silver cyanide, potassium silver thiosulphate, silver lactate, or platinum salts, especially Pt(NO₃)₂ or H₂PtCl₆, or nickel salts and copper salts, also optionally in the presence of additives such as brighteners, especially thiourea, saccharin, by an electrolysis operation in which the current collector serves as the cathode (3), and in the course of which the catalyst particles of the catalyst metal grow onto the current collector,
E) rinsing the oxygen-consuming electrode formed in D) with water and alcohol and then drying the oxygen-consuming electrode.

Preference is given to a novel process which is characterized in that the current collector has direct electrical contact connection with an external power source in the electrolytic deposition D), or the current is supplied through a graphite sheet (1) and a graphite spray intermediate layer (2) which rests on or has been applied to the current collector, and which are removed again after the electrolytic deposition D).

The novel oxygen-consuming electrode is preferably connected as a cathode, especially in an electrolysis cell for the electrolysis of alkali metal chlorides, preferably of sodium chloride or potassium chloride, more preferably of sodium chloride.

Alternatively, the oxygen-consuming electrode (OCE) can preferably be connected as a cathode in a fuel cell. Preferred examples of such fuel cells are alkaline fuel cells.

The invention therefore further provides for the use of the novel oxygen-consuming electrode for reduction of oxygen under alkaline conditions, especially in an alkaline fuel cell, for the use in drinking water treatment, for example for preparation of sodium hypochlorite or for the use in chloralkali electrolysis, especially for electrolysis of LiCl, KCl or NaCl.

The novel OCE is more preferably used in chloralkali electrolysis and here especially in sodium chloride (NaCl) electrolysis.

The process is, by way of example, performed as follows:

In step C), the electrolytic deposition of the catalyst particles in an electrolytic operation, the current collector mesh serves as the cathode (3) (see FIG. 1), onto which the catalyst particles of the catalyst metal grow and for which there is direct minus pole current supply to the current collector mesh via soldered-on wires; as an alternative, minus pole current supply is also possible via a graphite sheet (1) and a graphite spray intermediate layer (2) which rests on or is applied to the current collector.

The graphite spray intermediate layer can, for example, be washed off after production. The sacrificial anode used in the electrolytic deposition is especially a sheet of the catalyst metal (7), which is connected as the plus pole of the current supply.

With the aid of an elastic porous material (6), for example foam of polyurethane, rubber, viscose or cellulose, preference being given to cellulose which has been impregnated with the electroplating bath, all parts of the arrangement are, for example, pressed together for an electrolytic deposition. Due to the electrical field, as soon as current flows through the arrangement, the catalyst particles tend to grow at right angles to the OCE surface.

The invention is illustrated in detail hereinafter by the examples with reference to FIG. 1, but these do not constitute a restriction of the invention.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### BRIEF DESCRIPTION OF THE DRAWING

FIG. 1 depicts a schematic cross section through an electrolytic cell for production of the inventive oxygen-consuming electrode (not to scale).

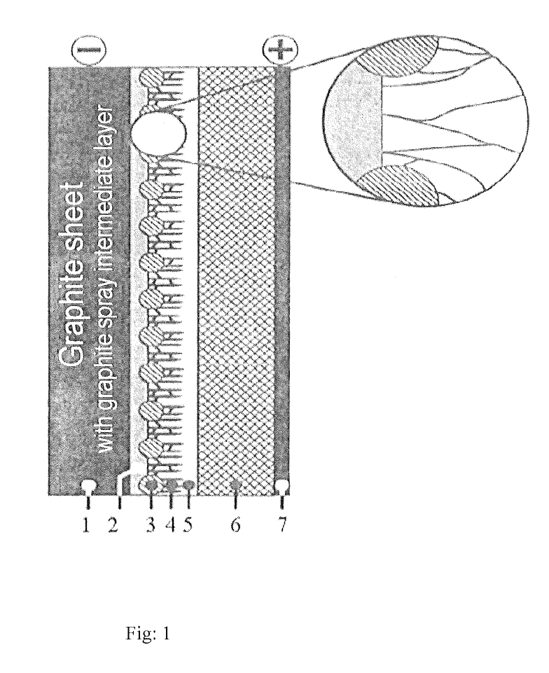

In the figure, the reference numerals have the following meanings:

1 graphite sheet (minus pole)

2 graphite spray intermediate layer

3 current collector

4 catalyst particles

5 porous PTFE

6 elastic porous material

7 metal sheet (plus pole)

### EXAMPLES

### Example 1

A sheet of a Gore-Tex® DB 10-0-100 gasket tape of thickness 1.0 mm was impregnated first with isopropyl alcohol and then with degassed water. A circle with a diameter of 41 mm was punched out. Lying horizontally on a fine nickel mesh, it was incorporated tightly into an electrolysis cell with an active area of about 10 cm². 2 molar degassed silver nitrate solution was introduced into the electrolysis cell and the cell was left to stand for one day, in order that the silver nitrate solution could penetrate into the pores of the PTFE film. With an intermediate cellulose layer of thickness about 2 mm, which had been impregnated with silver nitrate solution, a silver sheet anode of diameter 36 mm was pressed on with a weight of 2.3 kg. The current was supplied with wires soldered directly onto the nickel mesh, as the minus pole, and the silver sheet, as the plus pole.

The electrolytic operation was commenced with a current of 2 A for 15 s. Thereafter, 100 mA of current flowed at a cell voltage of less than 2 V for 3.5 h. After the electrolysis cell had been opened and rinsed, it was found that catalyst particles had grown through the porous PTFE film into the cellulose. They were removed as far as the surface of the PTFE film. A piece of the OCE produced was subsequently used in a half-cell test arrangement corresponding to the prior art with active area 3 cm² as the oxygen-consuming cathode in sodium hydroxide solution. In operation with pure oxygen, it achieved therein a current density of 50 A/m² for oxygen reduction at a potential of −400 mV against the standard hydrogen electrode. This shows that electrocatalytically active silver catalyst particles have formed, which are accessible both to the gaseous oxygen and to the sodium hydroxide solution.

### Example 2 (Comparative Example)

For comparison, in the same half-cell test arrangement, under the same conditions, a nonporous silver sheet was incorporated and only the electrolyte was saturated with oxygen. In this experiment, the current density was only 1 A/m²,

### Example 3

The experimental procedure was as in Example 1, except that, instead of the GoreTex DB 10-0-100 PTFE gasket tape, a GoreTex GR flat gasket and a flat-rolled fine nickel mesh were used. The degassed silver nitrate solution here had a concentration of 60% by weight (approx. 7 molar). The catalyst particles were deposited with a current of 20 A at cell voltage about 10 V within 30 s. When used as an oxygen-consuming cathode, the electrode produced achieved a current density of 1400 A/m² at a potential of −600 mV against the standard hydrogen electrode. The small ohmic decline in voltage of about 17 mV per kAm⁻² (measured by galvanostatic switch-off measurement), which is included in the electrode potential, demonstrates the impeccable contact of the catalyst particles both with the electrical current supply and with the sodium hydroxide solution electrolyte.

1. An oxygen-consuming electrode comprising a current collector and a gas diffusion layer with a catalytically active component, wherein the gas diffusion layer is in the form of a porous film of a fluorinated polymer into which fine catalyst particles of a catalyst metal with a mean diameter in the range from 0.05 μm to 5 μm and a mean length in the range from 10 μm to 700 μm have been introduced as the catalytically active component and are connected with electrical conduction to the current collector.

2. The oxygen-consuming electrode of claim 1, wherein the catalyst comprises silver as the catalytically active component.

3. The oxygen-consuming electrode of claim 1, wherein the catalyst particles have a mean diameter in the range from 0.1 μm to 5 μm and a mean length in the range from 10 μm to 700 μm.

4. The oxygen-consuming electrode of claim 1, wherein the current collector is in the form of a pervious, electrically conductive, flat structure.

5. The oxygen-consuming electrode of claim 4, wherein the current collector is in the form of a flexible textile structure.

6. The oxygen-consuming electrode of claim 1, wherein the material used for the current collector is nickel or silver-coated nickel.

7. The oxygen-consuming electrode of claim 1, wherein the porosity of the film of the fluorinated polymer is from 40% to 90%.

8. The oxygen-consuming electrode of claim 1, wherein the pores of the film of the fluorinated polymer have a mean diameter of from 0.1 μm to 10 μm.

9. The oxygen-consuming electrode of claim 1, wherein the density of the film of the fluorinated polymer is 0.3 to 1.8 g/cm³.

10. The oxygen-consuming electrode of claim 1, wherein the catalyst particles consist of silver.

11. The oxygen-consuming electrode of claim 1, wherein the catalyst particles have been deposited electrolytically on the current collector and in the pores of the film.

12. An alkaline fuel cell or a metal/air battery comprising the oxygen-consuming electrode of claim

13. An electrolysis apparatus comprising the oxygen-consuming electrode of claim 1 as an oxygen-consuming cathode.

14. A process for producing the oxygen-consuming electrode of claim 1, comprising at least the steps of:
A) providing a PTFE film and a current collector in the form of a pervious, electrically conductive, flat structure, which reaches into the film from step A) to a depth of up to at least half and at most ⅔ of the thickness of the porous film, and optionally bonding the film to the current collector by pressing,
B) impregnating the film of a fluorinated polymer, with a volatile organic solvent, and then at least partly displacing the solvent with water or an aqueous metal salt solution, optionally in the presence of additives,
C) optionally subsequently pressing the current collector into the film from step A) to a depth reaching up to at least half and at most ⅔ of the thickness of the porous film,
D) electrolytic deposition of the catalyst particles in the presence of aqueous metal salt solutions by an electrolysis operation in which the current collector serves as the cathode (3), and in the course of which the catalyst particles of the catalyst metal grow onto the current collector,
E) rinsing the oxygen-consuming electrode formed in D) with water and alcohol and then drying the oxygen-consuming electrode.

15. The process of claim 14, wherein the current collector has direct contact connection in the electrolytic deposition D), or the current is supplied through a graphite sheet (1) on which the current collector rests and a graphite spray intermediate layer (2) which has been applied to the graphite sheet (1), and in that the graphite sheet (1) and the graphite spray intermediate layer (2) are removed again after the electrolytic deposition D).

16. An oxygen-consuming electrode obtained from the process of claim 14.

17. The oxygen-consuming electrode of claim 1, wherein the porous film of a fluorinated polymer is porous polytetrafluoroethylene (PTFE)

18. The oxygen-consuming electrode of claim 4, wherein the pervious, electrically conductive, flat structure is a metallic mesh, nonwoven, foam, woven, braid or knit, or of an expanded metal.

19. The oxygen-consuming electrode of claim 5, wherein the flexible textile structure is formed from metal filaments.

20. The oxygen-consuming electrode of claim 8, wherein the pores of the film of the fluorinated polymer have a mean diameter of from 0.2 to 2 μm.
